(19) United States
(12) Patent Application Publication
(10) Pub. No.: US 2007/0000219 A1
(43) Pub. Date: Jan. 4, 2007

(54) Air purifier

(76) Inventors: Chan Jung Park, Suwon-si (KR); Young Saeng Kim, Incheon-City (KR)

Correspondence Address: STANZIONE & KIM, LLP, 919 18TH STREET, N.W., SUITE 440, WASHINGTON, DC, 20006, US

(21) Appl. No.: 11/298,581

(22) Filed: Dec. 12, 2005

(30) Foreign Application Priority Data
Jun. 30, 2005 (KR) 2005-58081

(51) Int. Cl. B01D 46/04

(52) U.S. Cl. 55/300

(57) ABSTRACT

An air purifier includes a vibrating member disposed adjacent to a dust filter, and first and second vibration motor assemblies disposed longitudinally and transversely on the vibrating member, respectively, to cause the vibrating member to vibrate in several directions. Each of the vibration motor assemblies has a case fixed to the vibrating member, a vibrating motor disposed within the case, and a cover to close the case. The vibration motor includes a stator fitted to a sheet member within the case, a rotor rotatably disposed within the stator, and an eccentric shaft connected to the rotor to generate vibration via an eccentric rotation of the eccentric shaft.

### CROSS-REFERENCE TO RELATED APPLICATIONS

This application claims the benefit under 35 U.S.C. §119 from Korean Patent Application No. 2005-58081, filed on Jun. 30, 2005 in the Korean Intellectual Property Office, the disclosure of which is incorporated herein in its entirety by reference.

### BACKGROUND OF THE INVENTION

1. Field of the Invention

The present general inventive concept relates to an air purifier, and more particularly, to an air purifier designed to allow dust that collects on a dust filter to be removed conveniently, rapidly and automatically.

2. Description of the Related Art

Generally, an air purifier comprises a filter unit to purify air and a blowing fan to forcibly blow the air within a housing. When the air purifier is operated to purify indoor air, the blowing fan forces the indoor air to pass through the filter unit to filtrate dust, odor and bacteria contained in the air that passes through the filter unit, and then forces the purified air to be discharged into a room.

The air purifier should have a compact structure for convenient installation at a suitable location in the room, and should have a high purifying capability. For this purpose, the air purifier is provided with various filters which have good filtering performance, deodorizing performance or sterilizing performance.

A dust filter is used to remove dust and foreign substances contained in air. The dust filter is formed of a material having a plurality of fine pores such that, as air flows through the fine pores, the dust and foreign substances contained in the air are collected on a surface of the dust filter, and then removed from the air to clean the air.

One example of conventional air purifiers having such a dust filter is disclosed in U.S. Pat. No. 5,702,507. The conventional air purifier disclosed therein comprises a dust filter and a blowing fan disposed within a case. The conventional air purifier is designed to remove dust from air by passing the air through the dust filter to be purified.

However, when the conventional air purifier is used for a predetermined period of time or longer, a surface of the dust filter is covered with dust and becomes blocked, so that an amount of air that can pass through the dust filter of the air purifier is significantly decreased, and severe noise is generated by the air purifier. As a result, the conventional air purifier has drawbacks in that the dust filter should be periodically taken out of the air purifier for maintenance (to remove the dust collected on the dust filter), creating an inconvenience. Additionally, if the dust is not periodically removed from the dust filter, a lifetime of the dust filter decreases.

In particular, for the conventional air purifier described above, dust particles are not easily detached from the dust filter due to electrostatic force generated on the surface of the dust filter. Thus, it is very difficult to remove the dust particles from the dust filter. Furthermore, some of the dust particles are often stuck on the dust filter, and are not detached from the dust filter, thereby deteriorating the filtering performance of the dust filter while significantly increasing a load of the blowing fan.

### SUMMARY OF THE INVENTION

The present general inventive concept provides an air purifier, designed to allow dust attached to a dust filter to be conveniently and rapidly removed from the dust filter without taking the dust filter out of the air purifier. The present invention general inventive also provides an air purifier, designed to prevent electrostatic force from occurring on a surface of the dust filter and to allow the dust to be easily detached from the dust filter.

Additional aspects of the present general inventive concept will be set forth in part in the description which follows and, in part, will be obvious from the description, or may be learned by practice of the general inventive concept.

The foregoing and/or other aspects of the present general inventive concept are also achieved by providing an air purifier, comprising a housing, a dust filter and a blowing fan equipped within the housing, a vibrating member disposed adjacent the dust filter, and a plurality of vibration motor assemblies provided on the vibrating member and disposed to vibrate in different directions therein to effectively remove dust attached to the dust filter.

The plurality of vibration motor assemblies may comprise first and second vibration motor assemblies disposed in a vertical direction and in a horizontal direction on the vibrating member, respectively.

Each of the plurality of vibration motor assemblies may comprise a case fixed on the vibrating member, a vibrating motor equipped within the case, and a cover to close the case.

The vibration motor may comprise a stator fitted on a sheet member within the case, a rotor rotatably disposed within the stator, and an eccentric shaft connected to the rotor to generate vibration via eccentric rotation of the eccentric shaft.

The vibrating member may have a lattice structure, and the case may be coupled to the lattice structure of the vibrating member.

The dust filter may be slanted at an angle within the housing such that an upper end of the dust filter is closer to a front side of the housing than a lower end of the dust filter, and the vibrating member may be positioned substantially parallel of the dust filter within the housing at a predetermined distance from a rear surface of the dust filter.

The air purifier may further comprise a tray disposed below the dust filter to collect the dust falling from the dust filter when the dust filter vibrates due to a vibration of the vibrating member.

A surface of the dust filter may be coated to prevent static electricity from accumulating thereon to easily remove dust therefrom.

The vibrating member may be formed of a resilient plastic material, and be separated from the dust filter by a distance less than an amplitude of the vibration of the vibrating member vibrating due to the plurality of vibration motor assemblies.

The foregoing and/or other aspects of the present general inventive concept are also achieved by providing an apparatus to purify air inside a room, the apparatus including a dust filter to purify air passing therethrough, and a vibrating part disposed adjacent to the dust filter to apply vibrations in different directions to remove dust attached to the dust filter by coming in contact with the dust filter while vibrating.

The foregoing and/or other aspects of the present general inventive concept are also achieved by providing an air filtering apparatus having an air flow passing through, the apparatus including a dust filter slanted with respect to a vertical direction so that dust particles from the air flow retained by the dust filter are allowed to fall vertically, and a dust removing module to clean the dust filter inside the apparatus by periodically shaking the dust filter.

The foregoing and/or other aspects of the present general inventive concept are also achieved by providing a vibrating member usable in an air purifier to shake a dust filter having dust collected thereon, the vibrating member having a resilient planar member, and at least one vibration generator attached to the resilient planar member at a predetermined position to vibrate the resilient planar member to shake a dust filter.

The foregoing and/or other aspects of the present general inventive concept are also achieved by providing a method of maintaining a dust filter in an air purifier free of dust particles, the method including disposing the dust filter slanted inside the air purifier to allow falling the dust particles retained by the dust filter from air flowing through to fall vertically, and periodically shaking the dust filter in different directions to make the dust particles fall.

### BRIEF DESCRIPTION OF THE DRAWINGS

These and/or other aspects of the present general inventive concept will become apparent and more readily appreciated from the following description of the embodiments, taken in conjunction with the accompanying drawings, of which:

FIG. 1 is a front perspective view illustrating an air purifier with a dust filter slanted therein according to an embodiment of the present general inventive concept;

FIG. 2 is a longitudinal cross-sectional view illustrating the air purifier of FIG. 1 having a vibrating member and one of a plurality of vibration motor assemblies disposed on a rear portion of the dust filter, according to an embodiment of the present general inventive concept;

FIG. 3 is a perspective view illustrating the vibrating member and the plurality of vibration motor assemblies of the air purifier illustrated in FIG. 2; and

FIG. 4 is a perspective view illustrating an inner structure of the vibration motor assembly included in the air purifier illustrated in FIG. 3, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

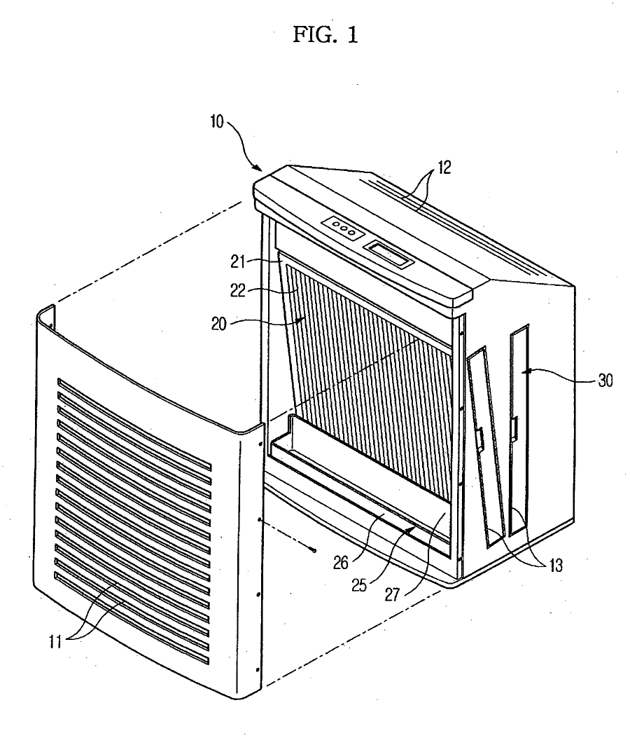

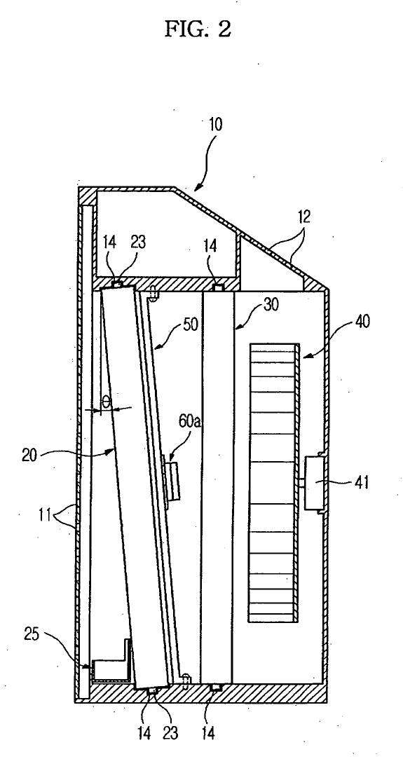

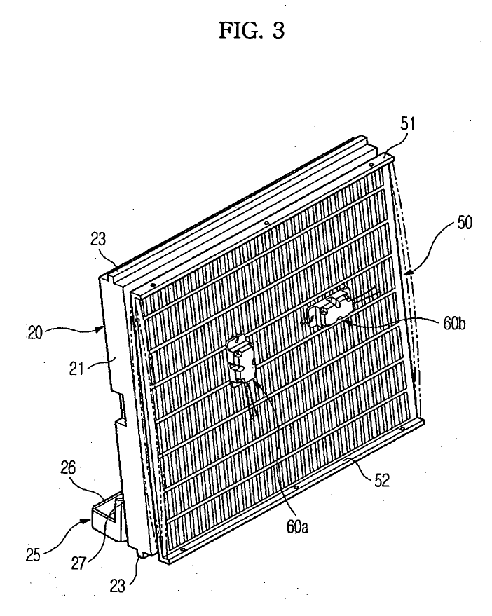

FIG. 1 is a front perspective view illustrating an air purifier with a dust filter 20 slanted therein according to an embodiment of the present general inventive concept. FIG. 2 is a longitudinal cross-sectional view illustrating the air purifier with a vibrating member 50 and a plurality of vibration motor assemblies 60a (and 60b, see FIG. 3) disposed on a rear portion of the dust filter 20, and FIG. 3 is a perspective view illustrating the vibrating member 50 and the plurality of vibration motor assemblies of the air purifier illustrated in FIG. 2. In the following description of the air purifier, according to the present embodiment, an air flow direction as air passes through the air purifier is used to describe relative positions of components.

As illustrated in FIGS. 1 to 3, the air purifier according to the present embodiment includes a box-shaped housing 10 defining an outer appearance of the air purifier, the dust filter 20 disposed inside the housing 10 to filter out dust and foreign substances from air and to purify the air, a blowing fan 40 disposed behind the dust filter 20 within the housing 10 to forcibly blow the air, the vibrating member 50 disposed adjacent to a rear side of the dust filter 20, and first and second vibration motor assemblies 60a and 60b, respectively, coupled to the vibrating member 50 to make the vibrating member 50 vibrate.

The air purifier may further comprise a deodorizing filter 30 positioned between the dust filter 20 and the blowing fan 40 to remove odors contained in the air. The air purifier may further comprise other filters to perform sterilization or anti-bacterial functions in addition to the deodorizing filter 30.

The housing 10 has a plurality of air inlets 11 formed on a first surface (e.g. a front side) through which indoor air flows into the housing 10, and a plurality of air outlets 12 formed at a second surface (e.g. at a rear side) through which purified air is discharged back into a room.

The air inlets 11 and the air outlets 12 may be positioned at various locations of the housing 10 according to an arrangement of the dust filter 20, the deodorizing filter 30, and the blowing fan 40 within the housing 10.

Slots 13 may be formed on one side of the housing 10 such that the dust filter 20 and the deodorizing filter 30 can be inserted into or removed from the housing 10 therethrough. As illustrated in FIG. 2, slide grooves 14 may also be formed on upper and lower inner surfaces of the housing 10 to enable the dust filter 20 and the deodorizing filter 30 to be inserted in or removed from the housing 10 to slide along the slide grooves 14.

The blowing fan 40 comprises a centrifugal fan having a plurality of plates that are arranged radially (i.e., a Sirocco fan) and is rotated at a high speed by a driving motor 41 to force indoor air to flow into the housing 10 and to circulate therein. However, the blowing fan 40 is not limited to a particular type of fan, but may be any fan that performs the intended purpose of the general inventive concept.

As illustrated in FIGS. 1 and 3, the dust filter 20 comprises a rectangular frame 21, and a filtering portion 22 fitted into the frame 21 to collect dust. The frame 21 has slide protrusions 23 formed on upper and lower ends thereof to be fitted into the slide grooves 14 to guide the dust filter 20 to slide into or out of the housing 10.

The filtering portion 22 may be detachably coupled to the frame 21 to be easily removable, and is formed of a porous material having a plurality of fine pores to prevent fine dust particles from passing through the filtering portion 22.

Additionally, a surface of the filtering portion 22 may be coated to prevent the dust particles from being stuck thereto and not to detach from the dust filter 20 due to electrostatic force occurring on the surface of the filtering portion 22. One example of coating is to apply TEFLON or metallic powders on the surface of the filtering portion 22 to prevent electrostatic force from occurring on the coated surface of the filtering portion 22. The entire surface of the filtering portion 22 may be coated to prevent the electrostatic force from occurring thereon, so that dust can be easily removed from the surface of the filtering portion 22.

Referring to FIGS. 1 to 3, the dust filter 20 is slanted at an angle θ with respect to a vertical direction in the housing 10, such that the upper end of the dust filter 20 is closer to the front surface of the housing 10 than the lower end of the dust filter 20. The slanted position of the dust filter 20 described above allows the dust that is attached to the surface of the dust filter 20 to fall directly to the bottom of the housing 10 without flowing down along the surface thereof when the vibrating member 50 vibrates.

If the dust filter 20 is disposed in the housing 10 at an excessively large angle θ, it takes up too much space in the housing 10, and if the dust filter 20 is disposed in the housing 10 at too small of an angle θ, the dust does not easily fall off the dust filter 20. Thus, the dust filter 20 may be disposed in the housing 10 at an angle θ in the range of 10˜45 degrees.

The air purifier may further comprise an elongated rectangular box-shaped tray 25 disposed below the dust filter 20 and open at an upper portion thereof to collect the dust and foreign substances falling from the dust filter 20. The tray 25 has a front plate 26, and a rear plate 27 extending upwardly more than the front plate 26 to prevent the dust collected in the tray 25 from being scattered upward from the tray 25, and then reattaching to the surface of the dust filter 20 by a suctioning force provided by the blowing fan 40. The rear plate 27 of the tray 25 slightly screens the lower portion of the filtering portion 22 of the dust filter 20.

Due to the above described structure of the tray 25, even though a considerable suction force of air may be generated on the front surface of the dust filter 20 via operation of the blowing fan 40, the dust collected in the tray 25 is prevented from being scattered upward from the tray 25, and then being reattached to the filtering portion 22 of the dust filter 20.

The vibrating member 50 is a thin resilient lattice-shaped plate. The vibrating member 50 has an upper end 51 and a lower end 52 fastened to upper and lower portions of the housing 10 by a fastener (i.e., screws), and is located close to a rear surface of the dust filter 20. The vibrating member 50 may be formed of a plastic material having good resilience. A gap between the vibrating member 50 and the dust filter 20 is less than a maximum amplitude of the vibrating member 50 which is vibrated by the plurality of vibration motor assemblies 60a and 60b. When the plurality of vibration motor assemblies 60a and 60b are operated, the vibrating member 50 strikes the rear surface of the dust filter 20 to vibrate the dust filer 20.

The plurality of vibration motor assemblies 60a and 60b may include a first vibration motor assembly 60a and a second vibration motor assembly 60b as illustrated in FIG. 3. The first vibration motor assembly 60a is disposed in a vertical direction (i.e., gravity direction) at the left side of the vibrating member 50, and the second vibration motor assembly 60b is disposed in a horizontal direction perpendicular to the vertical direction at the right side of the vibrating member 50. Accordingly, the vibrating member 50 vibrates in different vibrating directions on the right and left sides thereof, so that vibration is transmitted to the dust filter 20 and the filtering portion 22 in various patterns.

Although illustrated in FIG. 3 and described above that the first and second vibration motor assemblies 60a and 60b are disposed at the left and right sides of the vibrating member 50, respectively, it should be understood that the present general inventive concept is not limited to this arrangement, and that more or less vibration motor assemblies can be disposed at suitable locations on the vibrating member.

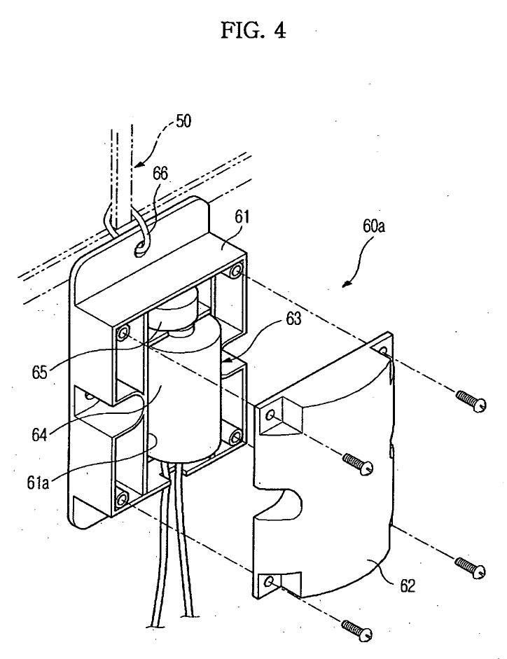

FIG. 4 is a perspective view illustrating an inner structure of the vibration motor assembly illustrated in FIG. 3, according to an embodiment of the present general inventive concept. Since the first and second vibration motor assemblies 60a and 60b may have the same structure but may be disposed in different directions, only the structure of the first vibration motor assembly 60a will be described hereinafter.

As illustrated in FIG. 4, the first vibration motor assembly 60a comprises a case 61 tightly fixed at upper and lower portions to the lattice-shaped plate of the vibrating member 50 by a metal strip 66, a vibration motor 63 located within the case 61, and a cover 62 to close the case 61.

The vibration motor 63 comprises a stator 64 fitted to a sheet member 61a within the case 61, a rotor (not shown) rotatably disposed within the stator 64, and an eccentric shaft 65 connected to the rotor and rotating therewith. Thus, when the rotor is rotated, the eccentric shaft 65 is eccentrically rotated to generate vibration, so that the case 61 and the cover 62 vibrate at the same time.

When the case 61 and the cover 62 vibrate at a high frequency via eccentric rotation of the eccentric shaft 65, the vibrating member 50 made of resilient material and coupled to the case 61 vibrates forward and backward as indicated by double dotted lines in FIG. 3.

Referring to FIGS. 1 to 4, if dust is accumulated on the dust filter 20 while using the air purifier for a predetermined period of time, the dust may be removed by operating the vibration motor 63 of the first and/or second vibration motor assembly (60a and/or 60b). That is, when the vibration motor 63 is operated, the vibrating member 50 vibrates at the high frequency together with the case 61 and the cover 62 of the first and/or second vibration motor assembly (60a and/or 60b) and the vibrating member 50 strikes the filtering portion 22 of the dust filter 20 at the high frequency.

Additionally, since the first and second vibration motor assemblies 60a and 60b are disposed in the vertical and the horizontal direction, respectively, on the vibrating member 50, the lattice-shaped plate of the vibrating member 50 vibrates vertically and horizontally, causing the filtering portion 22 of the vibrating member 50 to vibrate in different vibration directions with various patterns, so that the dust can be rapidly and effectively removed from the filtering portion 22 of the dust filter 20.

As such, the filtering portion 22 of the dust filter 20 also vibrates at the high frequency, so that the dust particles and foreign substances attached to the filtering portion 22 fall (i.e., are knocked off) and are accumulated in the tray 25. Because the dust filter 20 is slanted at an angle θ in the housing 10 such that the upper end of the dust filter 20 is disposed above the tray 25, and has the structure to prevent static electricity from accumulating on the filtering portion 22, the dust particles can be more rapidly and effectively detached from the filtering portion 22.

The present general inventive concept provides an air purifier in which dust particles and foreign substances attached to a dust filter can be rapidly and effectively detached from the dust filter due to multi-directional vibrations of a vibrating member disposed near the dust filter. Further, when vibration motors disposed in different directions on the vibrating member are operated, the vibrating member strikes a rear surface of the dust filter. Moreover, the dust filter is not required to be taken out of the air purifier to manually remove the dust from the dust filter, and dust collecting performance is enhanced while decreasing an air flow resistance thereon via periodic automatic dust removing operation, so that the air purifier according to the present general inventive concept can be operated without noise while enhancing overall air purifying performance.

Moreover yet, since the dust filter is slanted at a predetermined angle θ inside the air purifier, and has a surface that is treated (i.e., by coating) to prevent electrostatic force from occurring thereon, dust particles can be more rapidly and effectively removed from the dust filter, thereby increasing a lifetime of the dust filter.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An air purifier, comprising:
a housing;
a dust filter disposed within the housing;
a blowing fan disposed within the housing;
a vibrating member disposed adjacent the dust filter; and
a plurality of vibration motor assemblies provided on the vibrating member and disposed to vibrate in different directions therein to effectively remove dust attached to the dust filter.

2. The air purifier according to claim 1, wherein the plurality of vibration motor assemblies comprise:
first and second vibration motor assemblies disposed in a vertical direction and in a horizontal direction on the vibrating member, respectively.

3. The air purifier according to claim 1, wherein each of the plurality of vibration motor assemblies comprises:
a case fixed to the vibrating member;
a vibration motor provided within the case; and
a cover to close the case.

4. The air purifier according to claim 3, wherein the vibration motor comprises:
a stator fitted on a sheet member within the case;
a rotor rotatably disposed within the stator; and
an eccentric shaft connected to the rotor to generate vibration via eccentric rotation of the eccentric shaft.

5. The air purifier according to claim 3, wherein the vibrating member includes a lattice structure, and the case is coupled to the lattice structure of the vibrating member.

6. The air purifier according to claim 1, wherein the dust filter is slanted at an angle within the housing such that an upper end of the dust filter is closer to a front side of the housing than a lower end of the dust filter, and the vibrating member is positioned substantially parallel to the dust filter within the housing at a predetermined distance from a rear surface of the dust filter.

7. The air purifier according to claim 6, further comprising:
a tray disposed below the dust filter to collect the dust falling from the dust filter when the dust filter vibrates due to a vibration of the vibrating member.

8. The air purifier according to claim 1, wherein a surface of the dust filter is coated to prevent static electricity from accumulating thereon to remove dust.

9. The air purifier according to claim 1, wherein the vibrating member is formed from a resilient plastic material, and the vibrating member is separated from the dust filter by a distance less than an amplitude of a vibration of the vibrating member vibrating due to the plurality of vibration motor assemblies.

10. An apparatus to purify air inside a room, the apparatus comprising:
a dust filter to purify air passing therethrough; and
a vibrating part disposed adjacent to the dust filter to apply vibrations in different directions to remove dust attached to the dust filter by coming in contact with the dust filter while vibrating.

11. The apparatus according to claim 10, further comprising:
a fan to force the air to pass through the dust filter.

12. The apparatus according to claim 10, wherein the vibrating part comprises:
a lattice surface substantially parallel to the dust filter; and
at least one vibration generator to make the lattice surface vibrate.

13. The apparatus according to claim 12, wherein the at least one vibration generator is activated for a predetermined period to perform a dust filter cleaning operation.

14. The apparatus according to claim 12, wherein the vibrating part comprises at least two vibration generators to vibrate in different directions that are activated separately or simultaneously for predetermined periods of time to perform a dust filter cleaning operation.

15. The apparatus according to claim 12, further comprising:
a housing to enclose the dust filter, the fan and the vibrating part, the housing including a plurality of air inlets to allow air to enter therein, and a plurality of air outlets to allow the air to be discharged therefrom.

16. The apparatus according to claim 15, wherein the housing has one or more pairs of sliding grooves formed on upper and lower surfaces, and the dust filter has one or more pairs of protrusions formed on upper and lower edges to guide the dust filter sliding into the housing.

17. The apparatus according to claim 10, wherein the dust filter is slanted so that dust falls from a front surface into which air flows.

18. The apparatus according to claim 17, wherein the dust filter is slanted so that the front surface thereof makes an angle between 10° and 45° with a vertical direction.

19. The apparatus according to claim 17, wherein the vibrating part is disposed substantially parallel to the dust filter.

20. The apparatus according to claim 17, further comprising:
a tray disposed in front and bellow the dust filter to collect the dust falling from the front surface of the dust filter.

21. The apparatus according to claim 10, further comprising:
at least one of a deodorizing filter, a sterilizing filter and an anti-bacterial filter to pass the air therethrough.

22. The apparatus according to claim 10, wherein the dust filter comprises:
a rectangular frame; and
a porous material sheet detachably coupled to the rectangular frame to retain the dust.

23. The apparatus according to claim 10, wherein a front surface into which air flows is coated with a non-electrostatic coating to prevent forming of an electrostatic force that keeps dust from falling.

24. The apparatus according to claim 23, wherein the non-electrostatic coating comprises one of TEFLON and metallic powders.
